(19) United States
(12) Patent Application Publication
(10) Pub. No.: US 2012/0320164 A1
(43) Pub. Date: Dec. 20, 2012

(54) STEREOSCOPIC CAMERA WITH POLARIZING APERTURES

(76) Inventor: Lenny Lipton, Los Angeles, CA (US)

(21) Appl. No.: 13/524,753

(22) Filed: Jun. 15, 2012

Related U.S. Application Data
(60) Provisional application No. 61/520,859, filed on Jun. 16, 2011.

(51) Int. Cl. H04N 13/02

(52) U.S. Cl. 348/49; 348/E13.074

(57) ABSTRACT

A new technology using polarizing apertures for imaging both left and right perspective views onto a single sensor is presented. The polarizing apertures can be used to image each perspective view onto one or more sensors. Polarizing apertures within a single lens or within two lenses may be employed. The apertures' areas may be changed to control exposure and the design allows for interaxial separations to be varied to the reduced values required for stereoscopic cinematography.

The present application claims the benefit of U.S. Provisional Patent Application Ser. No. 61/520,859, “Stereoscopic Camera with Polarizing Apertures,” inventor Lenny Lipton, filed Jun. 16, 2011, the entirety of which is incorporated herein by reference.

### BACKGROUND OF THE INVENTION

1. Field of the Invention

The present invention relates generally to the art of stereoscopic cameras and lenses, and more specifically to stereoscopic camera and lens designs using polarizing apertures for imaging left and right perspective views on a single image sensor, or for selecting the left and right views for individual sensors using novel means to vary the interaxial separation.

2. Background of the Invention

The art of stereoscopic photography and cinematography has been held back because of the lack of a convenient means to reduce the interaxial separation between lenses to less than the distance between the eyes. The art taught here to overcome this problem applies to both stereoscopic cinematography and still photography.

In addition to the usual planar camera controls allowing for focusing, zooming, and setting the exposure, stereoscopic cinematography involves two additional controls: adjusting the zero parallax location (commonly called setting the convergence), and setting the interaxial (mistakenly called interocular or interpupillary) separation. The zero parallax setting (ZPS) controls the image location in space during projection. The interaxial setting controls the strength of the stereoscopic effect. Together these influence both the appearance and the ability to comfortably view the projected image.

The term “interaxial” or “interaxial distance” refers to the distance between the left and right lens axes. Those who are not familiar with the art expect stereoscopic photography and cinematography to use an interaxial equal to the average human interocular spacing of 65 mm or 2.5 inches. Cinematography meant for theater and video screens cannot be done this way, especially for photography given the distances encountered on a production set and most especially for subjects close to the camera.

For photography in which the interaxial corresponds to the interocular distance, in the circumstances described above, projection on theater-size screens will often produce background parallax values that greatly exceed the interocular distance. Fusion of such image points requires the eyes' lens axes to diverge, and this can be uncomfortable for most people. In addition, this kind of photography can lead to the audience perceiving the image as being elongated. When displaying such images on smaller screens for home viewing, small interaxials reduce parallax values and mitigate the breakdown of the habituated accommodation and convergence response.

In order to address the problem of interaxial reduction modern cinematographers use variations of a design by Floyd Ramsdell, U.S. Pat. No. 2,413,996, filed in 1944. In this design, the lens axes of the cameras are at right angles to each other with one lens looking through a semi-silvered mirror (sometimes referred to as a beam splitter, or pellicle [pellicule] or half-silvered mirror) with the other looking at the reflected image. The semi-silvered mirror is at 45 degrees to the cameras' lens axes, bisecting the lenses' axes. By such means it is possible to greatly reduce the effective interaxial separation.

It is well known to stereographers and cinematographers that the interaxial distance must often be set in the range of 1.5 to 0.125 inches—a far cry from the 2.5 inch average interocular distance in humans. Thus it is necessary to employ the beam-splitter rigs (the term of art used by the film industry) mentioned above. But splitter rigs are often big and clumsy and hard to operate and the bane of the existence of cinematographers because they may require time consuming and repeated realignment. In addition, these rigs require significant financial expenditures because the images they produce require post-production rectification or symmetrization to properly coordinate the left and right images to conform to the principal of binocular symmetries enunciated in “Foundations of the Stereoscopic Cinema”, 1982, Van Nostrand, New York.

Beam-splitter rigs are especially prone to producing illumination (density and color) asymmetries and geometrical asymmetries. For example, the transmission and reflection characteristics of a semi-silvered mirror differ leading to left and right images with different color rendition or image density. The other major cause of viewer discomfort is poor photography, which is beyond the scope of these teachings.

Binocular stereoscopic photography depends on the capture of left and right images taken from two related positions. It is well known in the art that the lens axis itself determines the centerline of the perspective view and this is used in the present design to create reduced interaxial separations. Single lenses with dual apertures have been employed in fields such as microscopy and endoscopy but what is uniquely taught here, in one embodiment, is the use of a polarizing aperture and the spatial multiplexing of perspective images by means of a patterned polarizer in intimate juxtaposition with a single image sensor. In another embodiment, polarizing aperture technology is uniquely used in combination with two sensors. These designs overcome the prior art beam-splitter rigs' limitations.

### DESCRIPTION OF THE DRAWINGS

FIG. 1 is a schematic representation of a single lens stereoscopic camera using polarizing apertures and patterned polarizing sensors;

FIG. 2 is a schematic representation of a single lens embodiment using polarizing apertures and two sensors;

FIG. 3 is a schematic representation of a two lens embodiment with mechanical interaxial adjustment using polarizing apertures and patterned polarizing sensors;

FIG. 4 is a perspective schematic representation of a polarizing aperture;

FIG. 5 is a diagrammatic representation of various patterned polarizer arrangements;

FIG. 6 is a schematic representation of a Bayer Pattern sensor overlaid with a quincunx patterned polarizer;

FIG. 7 is a perspective diagram of an electro-optical polarizing aperture;

FIG. 8A is one schematic view of an electro-optical aperture design seen from the sensor's point of view;

FIG. 8B is another schematic view of an electro-optical aperture design seen from the sensor's point of view;

FIG. 8C is a schematic illustration of one possible means for producing a pixel based EOPA; and

FIG. 9 is a representation the electrical driving means for the electro-optical aperture.

### DETAILED DESCRIPTION OF THE INVENTION

The present design varies the interaxial separation by changing the distance between the lens (or lenses) with polarizing apertures. In one embodiment, a single imaging surface covered by a patterned polarizer is used for spatial multiplexing, and in another embodiment a semi-silvered mirror or wire-grid polarizer is used to divert each perspective image to its own polarizer covered sensor. Mechanical and electro-optical polarizing apertures are also disclosed.

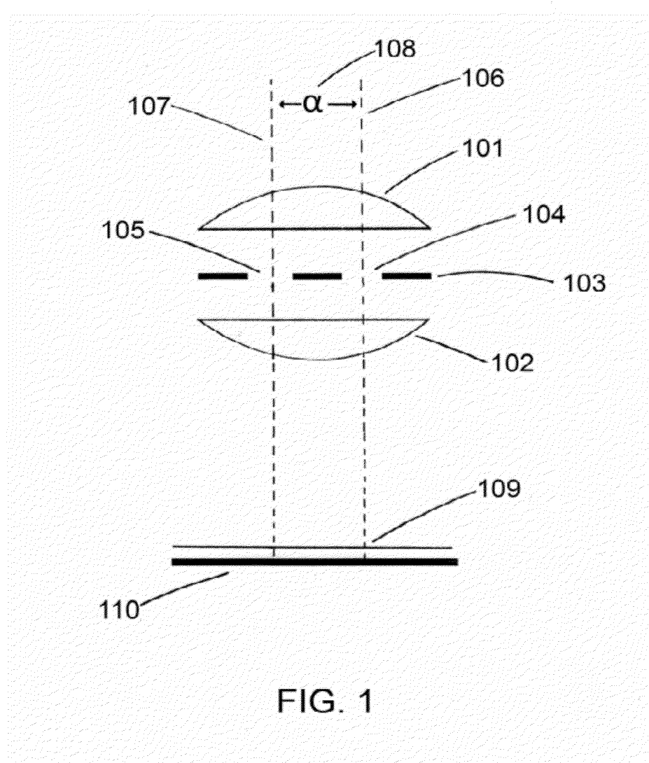

FIG. 1 depicts one embodiment of the present design. A photographic lens is made of multiple elements 101 and 102 which depict its construction. An actual camera lens is complex and made up of multiple elements. The example shown here has been simplified to two elements to clarity the explanation, but more or different lens elements may be employed. Left lens axis 107 and right lens axis 106 are shown as dotted lines and separated by interaxial distance a 108. As is the case in all similar figures, the lens axes are parallel, lying in the horizontal plane, and orthogonal to electronic imaging surface 110. The position of the apertures 104 and 105, which are part of polarizing aperture device 103, determines the location of the axes. The lens may have a fixed focal length or it may be a zoom lens. In the case of a zoom lens there are no geometric asymmetries that will be introduced for the left and right images as a result of mismatched focal lengths during zooming or from differential recentration of pairs of optics. Light from each aperture covers the entire sensor 110 after having passed through patterned retarder 109.

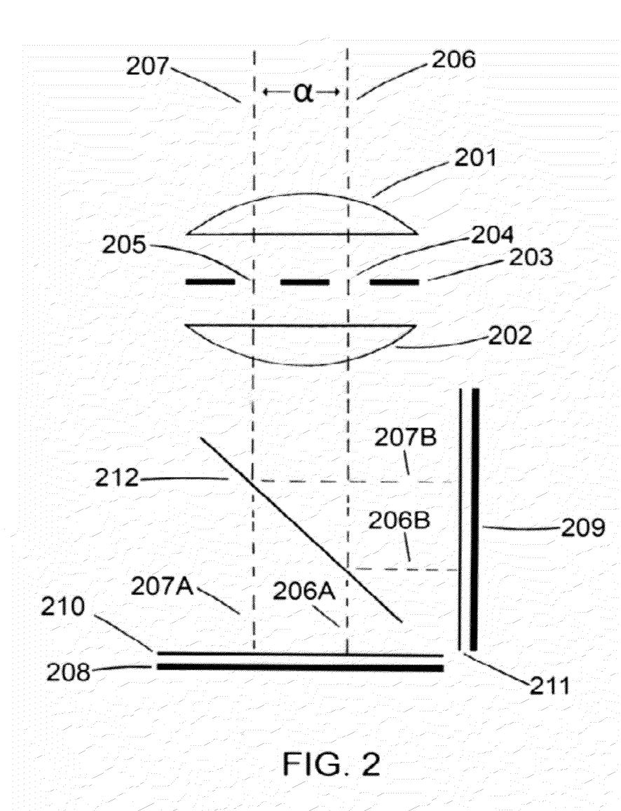

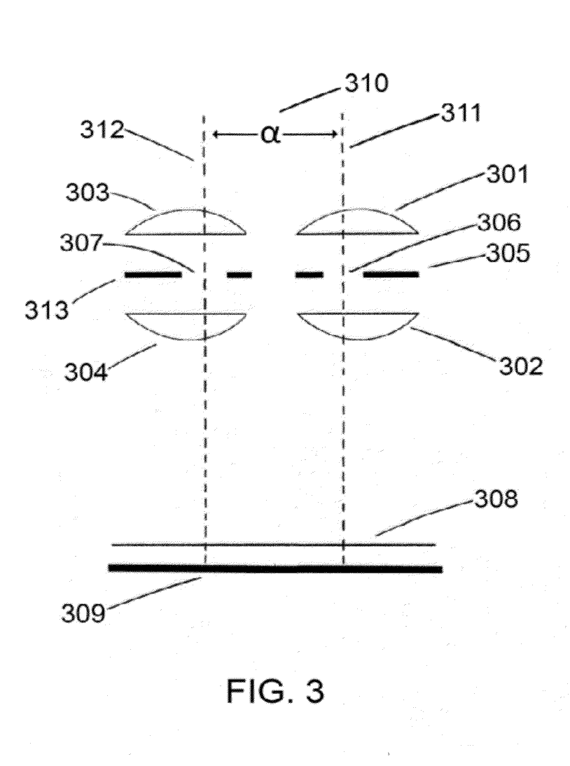

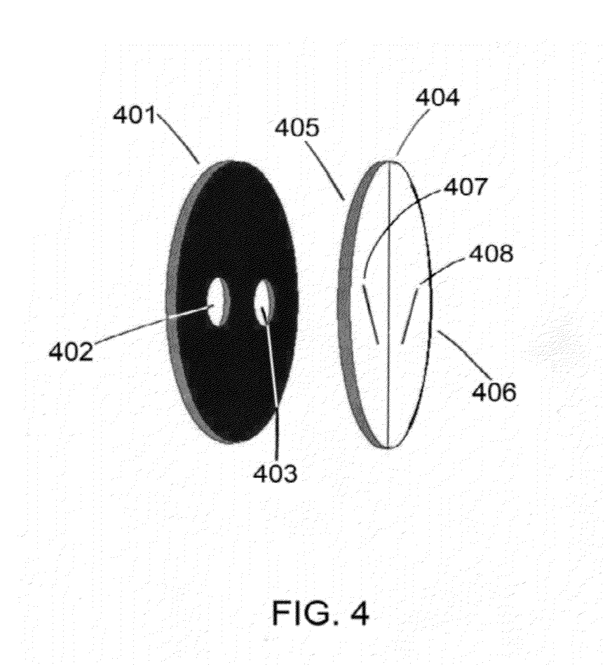

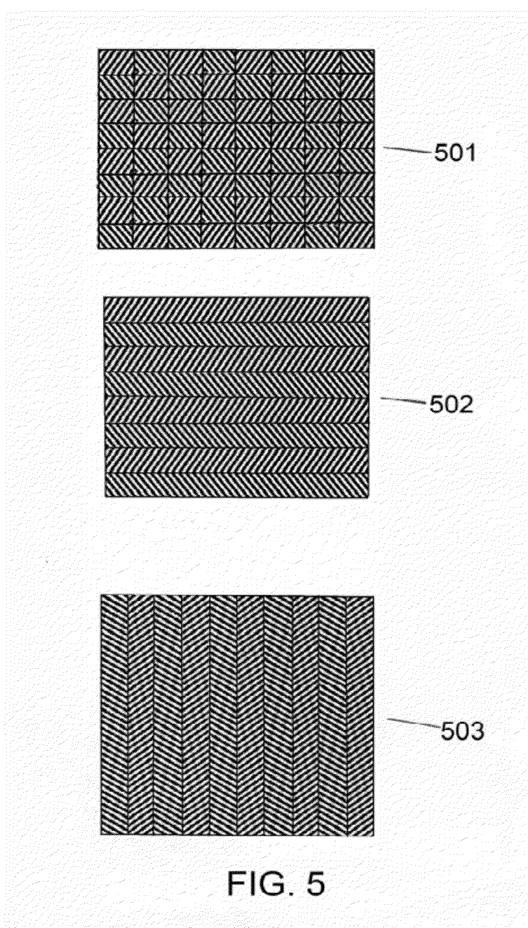

Patterned polarization analyzer device 109 is in intimate juxtaposition with electronic sensor 110. Versions of element 109 are depicted in FIG. 5 and are described below. A detailed description of a mechanical version of the polarizing aperture device 103 is given with the help of FIG. 4, a schematic perspective view. From FIG. 4, aperture plate 401 is made of two apertures; left perspective light passes through aperture 402 and right perspective light passes through aperture 403. Circular apertures are depicted whose centers are bisected by axes 106 and 107 with reference to FIG. 1 with interaxial separation a. Similarly, FIGS. 2 and 3 have their lens axes pass through the center of each circular aperture and it is the distance between these axes that determine the interaxial separation.

Although circular shapes are shown in FIG. 4, photography is replete with many other aperture designs. Many diaphragm mechanisms have been designed and even a device as simple as a Waterhouse stop, with interchangeable fixed openings, may serve in this arrangement. A simple slide-in dual aperture made of thin metal or plastic, each opening covered with polarizing filters whose axes are orthogonal, will suffice in the present design. A set of such slide-in apertures with openings of appropriate sizes to suit exposure conditions with different spacings apart can be offered to suit different photographic requirements. In addition to varying the size of the aperture opening, to control both exposure and depth of field, the distance between the apertures can be varied to change the interaxial setting. There are many possible mechanical solutions for varying the distance between apertures, and such prior designs are not the subject of this disclosure.

With reference to FIGS. 1, 2, and 3, a will vary symmetrically about a vertical center line bisecting the optical system, but asymmetrical locations of the apertures will also fulfill the objective of changing the interaxial spacing.

Polarizer assembly 404 is made up of two semi-circular linear sheet polarizers 405 and 406 whose axes 407 and 408 are orthogonal, and as depictured here at 45 and 235 degrees, respectively, to the horizontal. Although sheet polarizers are discussed, wire-grid polarizers will serve in the design as well. Also, while linear polarization has been described, those conversant with the art will appreciate that circular polarization may be employed as well. The device functions whether the polarizer assembly 404 is before or after the aperture plate 401. FIG. 4 assumes that image forming light passes from the visual world to the image sensor from left to right.

The use of polarizer light to select left and right images may introduce an asymmetrical reflection artifact since light in the sky or reflected from surfaces in the visual world is often polarized. This can be overcome by use of a retarder or retarder stack of appropriate value and orientation ether in front of the lens or within the lens and in front of the aperture device's polarizer.

The patterned linear polarizers depicted in FIG. 5 have orthogonal axes, represented by hatching, to insure appropriate extinction and transmission of the appropriate left and right images passing through the polarizing apertures. Such patterned polarizers are well known in the art and can be manufactured by several means. As noted, linear polarization is assumed, but one skilled in the art will recognize that circular polarization will serve. There may be no useful purpose to circular polarization because the orientation of the polarizer axes remains fixed and linear polarizers exhibit less cross talk. The combination of polarizing apertures and a patterned polarizer allows a single sensor to capture both left and right perspective views; this provides pixel sequential or spatial multiplexing of the two images. 501 shows a checkerboard pattern, 502 an interline pattern of horizontal lines, and 503 a vertical pattern of alternate polarization axes.

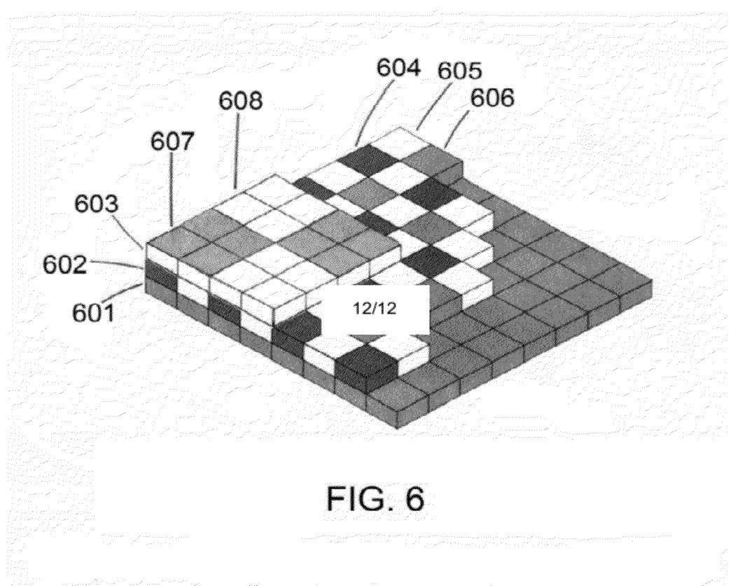

FIG. 6 is a diagram of a Bayer Pattern sensor made up of underlying sensor pixel array 601 and filter array 602. One publically available discussion of a Bayer Pattern sensor recites the following: “A Bayer filter mosaic is a color filter array (CFA) for arranging RGB color filters on a square grid of photosensors. Its particular arrangement of color filters is used in most single-chip digital image sensors used in digital cameras, camcorders, and scanners to create a color image. The filter pattern is 50% green, 25% red and 25% blue, hence is also called RGBG, GRGB, or RGGB.”

Underlying sensor pixel array 601 can be a charge coupled device or any other electronic sensor suitable for photographic imaging. Covering underlying sensor pixel array 601 is Bayer Pattern filter array 602 consisting of a triad of optical filters which utilize two green filters 605, shown as white squares, one red filter 606, shown as gray squares, and one blue sensor 604, shown as dark squares. Bayer Pattern technology is generally understood to those skilled in the art and is used here because of its wide-spread use.

The structure of the color imaging sensor determines the patterned polarizer design that will be most effective to use. For the Bayer Pattern a quincunx or checkerboard polarization pattern 501, which is layered on top of the sensor 601 and colored mosaic 602, is shown at point 603, made up of alternate states of polarization covering triads given by elements 607 and 608. Elements 607 and 608, squares of polarization with orthogonal axes, cover a Bayer triad made up of two green pixels, one red pixel, and one blue pixel—one polarization state for each perspective. The quincunx pattern is especially useful because it is known that diagonal sampling provides benefits with regard to preserving the resolution of each image. Most probably the patterned polarizer overlays the color filters but can function under the color filters. Other pixel color sensor patterns are vertical columns of RGB striped filters, and pattern 503 can be used in conjunction with that design. A horizontal pattern for alternating lines of perspective views is depicted by pattern 502.

The light passing through the apertures becomes polarized with orthogonal axes and the patterned polarizer has an orthogonal polarization axes orientation to match. The patterned polarizer selects light from the two apertures and arranges the light in a pixel pattern that can be sorted out to provide left and right views. The incoming left and right views destined for the sensor are mixed together after the polarizing apertures but can be separated by means of analyzing the polarization information since the patterned retarder either transmits or blocks a perspective view spatially based on the polarization state of the light having passed through each aperture.

Such a technique will, by using half of the pixels for each perspective, reduce the spatial resolution for each perspective. However there are algorithms that can make use of such “half images” and smooth out discontinuities and interpolate missing information to adequately compensate for the loss. There has been a steady increase in the resolution of sensors. There are now 4000 pixel sensors; 4000 true RGB pixels along a horizontal line. Even higher resolution sensors are in development whose deployment will mitigate final resolution loss. Below, with reference to FIG. 2, art is taught to capture full image resolution for each perspective view. The art of the processing of RGB pixels and their two-view stereoscopic counterpart to produce channels of left and right perspective information is generally understood to one skilled in the art.

The camera components—lens, camera body, and sensor—are no longer a limiting factor with regard to stereoscopic camera size for small interaxial settings. The polarizing apertures combined with the patterned retarder in juxtaposition with the sensor allows for reduction in interaxial and a compact design. The distance of the interaxial separation a, as depicted in FIG. 1 (and FIGS. 2 and 3) can be varied. The aperture device 103 consists of means to change the separation between apertures 104 and 105 so that they can move horizontally either closer together or further apart. As the apertures move along the horizontal, a new interaxial is established at the optical center of each aperture. A mechanical means can be provided to vary the distance between the apertures or, as will be explained below, an electro-optical means can also be provided.

FIG. 2 has image forming optics similar to FIG. 1 but two sensors are used so that full resolution of both perspectives views is captured. A complex lens is shown made up of lens components 201 and 202. Aperture structure 203 is within the lens and has polarizing apertures 204 and 205. Left and right image forming polarized light passing through these apertures has orthogonal axes. Interaxial α is determined by lens axes 206 and 207. Element 212 in one embodiment is a semi-silvered mirror and in another embodiment is a wire-grid polarizer. In either case element 212 is within a plane which bisects the orthogonal planes of sensors 208 and 209. Line 207A is a continuation of lens axis 207 as transmitted through 212, and line 207B is a continuation of lens axis 207 as reflected by element 212. Line 206A is a continuation of lens axis 206 as transmitted through element 212, and line 206B is a continuation of lens axis 206 as reflected by element 212. The axes are the central rays of each perspective view and are meant to be a representation of the image forming bundles.

Polarizer 210 has an axis either parallel or orthogonal to that of the axes of polarized light transmitted by apertures 205 or 204. Polarizer 210 covers image sensor 208. Polarizer 211 has an axis either parallel or orthogonal to that of the axes of polarized light transmitted by apertures 205 or 204. Polarizer 211 covers image sensor 209, and the axes of polarizer 210 and polarizer 211 are orthogonal.

For the case of a semi-silvered mirror used for element 212, light from the apertures 204 and 205 is both transmitted and reflected to the image sensors 209 and 208 whose plane surfaces are orthogonal. As noted, the transmitted or reflected continuations of the lens axes are indicated by dotted lines 206A, 206B and 207A and 207B. Polarizers 210 and 211 will either pass or block light from one or the other apertures so that only one of the two perspective views is seen by each sensor. In this way a stereopair is recorded, one view by sensor. Unlike the embodiment of FIGS. 1 and 3, this arrangement captures full resolution, rather than half resolution, images. Those skilled in the art will recognize that element 212 partially polarizes the reflected rays 206A and 207B, but a retarder or retarder stack placed in the optical path between element 212 and polarizer 211 can appropriately reorient the axis.

Thus light from each polarizing aperture is treated so that it can reach only one of the two available sensors. The sensors lie in planes that are orthogonal to each other with a semi-silvered mirror between them whose plane is at 45 degrees to the plane of each sensor. Light rays from both polarizing apertures are reflected by the semi-silvered mirror onto one sensor, and polarized light from the two apertures is transmitted by the semi-silvered mirror. Thus image forming light from both perspective views reaches the polarizers covering each sensor. Since the polarization axes of the light emerging from the apertures is orthogonal, and the axes of the sensor polarizers are orthogonal but aligned to be parallel or orthogonal to the axes of the light emerging from the apertures, the sensor polarizers block or transmit image light appropriately so that only the right perspective view will be seen by one sensor the left by the other.

For the case in which element 212 is a wire-grid polarizer, element 212 transmits or occludes light from the polarizing apertures. The wire-grid polarizer has its transmission and reflection polarization axes parallel or orthogonal to the polarized light axes of the light passing through the polarizing apertures. In this case, polarizers 210 and 211 are clean-up polarizers that are highly transmissive but in combination with the wire-grid polarizer result in better extinction of unwanted images than if element 212 is used alone. The wire-grid polarizer works in the following manner—unpolarized light at 45 degrees to its plane surface will be reflected linearly polarized and light transmitted will be similarly linearly polarized but the reflected and transmitted rays have their axes orthogonal. Thus light from one of the polarizing apertures is substantially blocked and light from the other is substantially transmitted.

Light from the apertures 204 and 205 is both transmitted and reflected to image sensors 209 and 208 whose surfaces are orthogonal as represented by the lens axes and indicated by dotted lines 206A, 206B and 207A and 207B. Element 212, while an effective polarizer, is not perfect and unwanted rays will leak through. These rays are analyzed with the help of clean-up polarizers 210 and 211. Unwanted residual light resulting in a ghost image is analyzed by clean-up polarizers 210 and 211. In combination with element 212, clean-up polarizers 210 and 211 either pass or block light from one or the other apertures so that only one of the two perspective views is seen by each sensor. In this way a stereopair is recorded, each half of the pair by each sensor, namely sensor 208 and sensor 209 respectively. Unlike the embodiment given with the help of FIGS. 1 and 3, full resolution, rather than half resolution, images are captured.

Thus light from each polarizing aperture is treated so that it can reach only one of the two available sensors. The sensors lie in planes that are orthogonal to each other with a wire-grid polarizer between them whose plane is at 45 degrees to the plane of each sensor. Light rays from one polarizing aperture are reflected by the wire-grid onto one sensor and polarized light from the other apertures will be transmitted by the wire-grid polarizer, which as noted above requires the help of clean-up polarizers located in juxtaposition with the image sensors. In this way, the combination of wire-grid polarizer and cleanup polarizers treat the apertures' polarized light to block or transmit image light appropriately so that the appropriate perspective view will be seen by each sensor.

A double lens system, described with the help of FIG. 3, can also be used with the art taught with the help of FIG. 2, as one skilled in the art will readily appreciate.

FIG. 3 is similar to FIG. 1 but two lenses are used that can be translated left to right along a straight line parallel to the surface of the sensor in a plane that bisects the center of the sensor and is parallel to the horizontal edge of the sensor. In this case, lens axes 312 and 311 remain perpendicular to the plane of the sensor 309. In this way the interaxial separation a 310 can be increased beyond that which is practical if a single lens is used. The right multi-element lens is indicated by parts 301 and 302. Left lens is indicated by parts 303 and 304. The right lens axis 311 and left lens axis 312 are separated by interaxial separation a 310 and are parallel. The aperture structure 305 has right polarizing aperture 306 and left polarizing aperture 307. The patterned polarizer 308 and image sensor 309 are similar to those elements previously described with the aid of FIGS. 5 and 6.

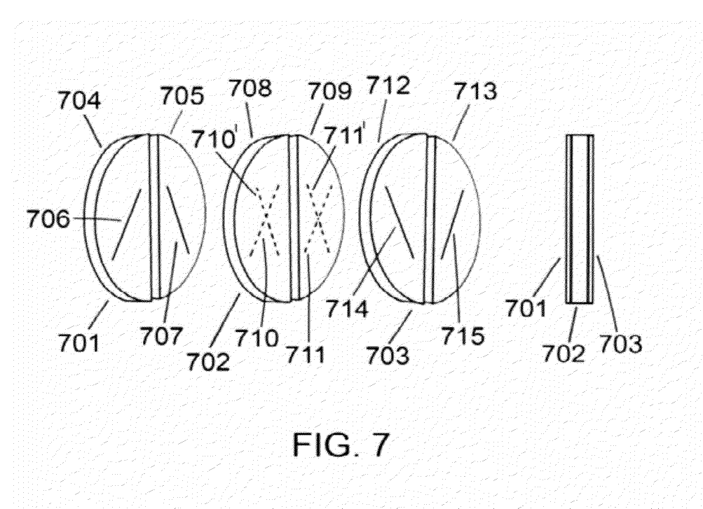

Despite the body of prior mechanical art for aperture designs and various means to combine this with the ability to move these apertures with respect to each other there are instances in which it is beneficial to use the electro-optical polarizing aperture (EOPA) explained by reference to FIG. 7. Such a device can be used to control both the size and shape of the aperture and also to vary the interaxial separation while outputting the required polarized light for spatial multiplexing in combination with the patterned retarder. The EOPA can be substituted for the mechanical polarizer arrangement taught with the help of FIG. 4.

FIG. 7 is partly a perspective schematic drawing and partly a side view of an EOPA. The EOPA can be activated to vary the interaxial separation, the size of the apertures for exposure control, and it will transmit left and right image light whose polarization axes are orthogonal. Light enters from the left and passes through the parts to the right. The side view at the right of FIG. 7 shows first polarizer ensemble 701, liquid crystal (LC) cell ensemble 702, and second polarizer ensemble 703. These parts are depicted in the adjacent perspective schematic view in more detail. In practice the parts are laminated or otherwise joined together to form a convenient package and also to reduce material to material light losses. Polarizer ensembles 701 and 703 axes' are orthogonal. Each ensemble is shown to be formed by two semi-circular halves, one for the left and one for the right aperture. Thus ensemble 701 is made up of semi-circular linear polarizers 704 and 705, whose axes' 706 and 707 are orthogonal. Linear sheet polarizers or wire-grid polarizers may be used.

The arrangement of parts in FIG. 7 for didactic simplicity is taught in the context of the single lens dual polarizing apertures shown in FIG. 1, but it can be applied to the dual lens art taught in FIG. 3. For a single lens the EOPA occupies the circular area available of the aperture device 103. Each aperture half is a semi-circle and each half is devoted to its perspective view. The EOPA structure can be rectangular with two rectangular perspective halves fitted to a housing that extends beyond the lens proper. Such an approach might be considered for a camera designed with a built in lens where the excess LC cell area is concealed by the camera body. Nonetheless, the manufacture of LC parts of circular shape is generally known to those skilled in the art.

The LC cells making up ensemble 702 are cells 708 and 709 which are driven independently, each with independent areas or pixels to be driven, to create their own apertures and to vary α, and also to produce linear polarization outputs that have orthogonal axes. The apertures are of the same size and shape and are equidistant from the nominal lens axis. Therefore, the left and right aperture openings are bilaterally symmetrical with respect to the vertical diameter that separates them for the single lens configuration.

LC cell ensemble 702 is made up of two semicircular LC parts 708 and 709, whose diameters are aligned with the diameters of the polarizer parts. The LC cells may be of various types but what is described, without any loss of generality, are twisted nematic (TN) or super twisted LC cells. TN LC technology is well understood but a cursory explanation is provided here.

An LC cell is made up of a thin layer of LC captured between two parallel plane sheets of glass. The inner facing surfaces of the glass are coated with a transparent conductor over which is coated a thin director alignment layer. The layer is rubbed to suggest an orientation for the liquid crystal directors, which are dipoles, whose orientation can be changed by the application of a voltage to the conductors. The voltage creates an electric field within the cell. In the case of TN cells, the facing director alignment layers have rub directions that are orthogonal. With no voltage applied to create a field the directors follow a spiral orientation and the passage of linearly polarized light through their bulk is explained by optical activity and their aggregate behavior is anisotropic. When the field is applied, by means of applying voltage to the facing conductor layers, the directors become aligned with the field and the cell optics become isotropic.

Specifically, one set of rub layers for cell 702 have rub directions of the director alignment layers indicated by dashed lines 710 and 711, and are immediately adjacent to polarizer ensemble 701. The other set of rub directions are shown as dotted lines for cell 702, 701′ and 711′, and are immediately adjacent to polarizer ensemble 703. The axes of linear polarizers 708 and 709, shown by lines 714 and 715, are orthogonal. The axes of polarizers adjacent to the LC cell ensembles are parallel with the adjacent director alignment or rub layers of each cell. This is the standard way that TN parts are made, producing the highest possible dynamic range. Thus rub direction axis 710 is parallel to polarizer axis 706 and rub direction 710′ (dotted line) is parallel to polarization axis 714. And axis 711′ is parallel with axis 706 and axis 711 is parallel with axis 715.

The left image forming light passing through first polarizer 704 with axis 706, LC cell 702 with facing rub axes 710 and 710′, and second polarizer 703 with axis 714 will be considered. The incoming polarized light's axis is parallel to the immediately adjacent alignment layer's rub direction. The polarized light's electric vector, as it passes though the LC cell and the spiral staircase of directors, is rotated through 90 degrees. By means of this rotation of the axis of light polarized by filter 706, whose polarization axis is parallel to the rub axis 710 of LC cell 702, the polarization axis is realigned to be parallel with the rub axis 710′, and that of the exit polarizer 714. But when cell 702 is energized the directors become oriented so that their length is parallel to the field and the LC material is isotropic. Thus the unchanged polarization axis of the light emerging cell 702 is orthogonal to polarization axis 714 of sheet polarizer 703 and transmission is blocked and the semicircular part will be opaque in this its closed state.

The parts for the right image, 705, 709, and 713, have their axes oriented orthogonally to their left image counterparts so that polarized light emerging in the open state will have its axis orthogonal to the right image parts' open state. This is of particular importance since the polarizing apertures' right and left axes must be orthogonal to work properly in concert with the patterned polarizer.

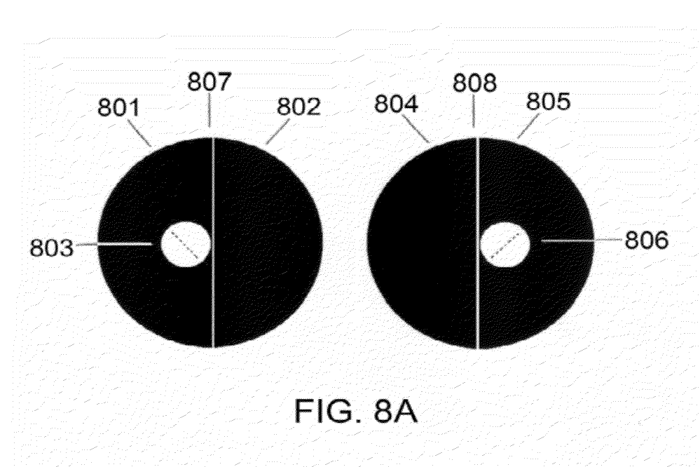

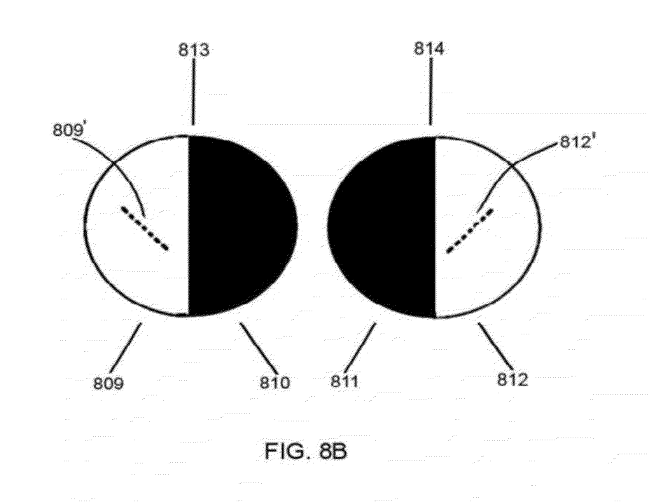

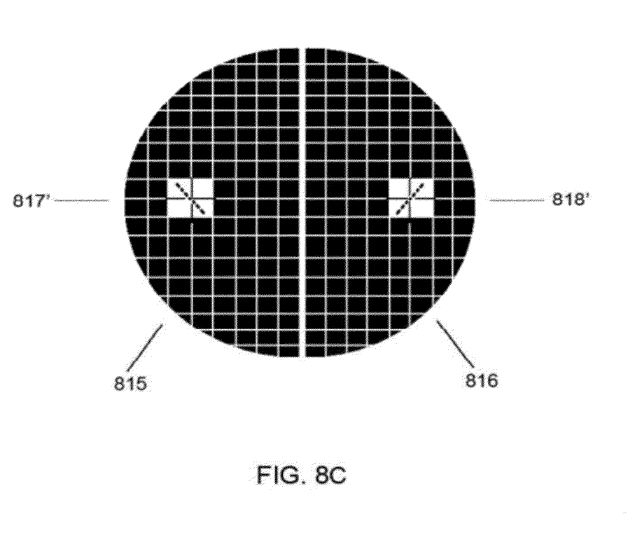

The size and shape and location of the apertures can be altered by two well known means for pixel addressing since LC displays are of two general types: Those with pixels addressed by means of transistors associated with each pixel or those that are edge driven and use an electrode and designed dielectric pattern to address various cell areas. The former is typically used for display monitors and the later for alpha-numeric displays. The size, shape, and interaxial separation of the apertures can be determined by means of addressing pixels within the EOPA device. Pixels in the open state transmit light, and those in the closed state block light. Open state light for the left and right halves or left and right lenses of the EOPA device(s) have their polarization axes oriented orthogonally to provide the first step required for image selection. Examples of how the addressing of pixels works are given in FIGS. 8A and 8B.

FIG. 8A is a diagram of an EOPA device as it would appear to an observer looking at the device from the direction of the sensor toward the lens. Elements 807 and 808 are the same EOPA, but each viewed through polarizing filters whose axes are orthogonal and also either parallel or orthogonal to the axes of the apertures' polarization axes. The axes' orientation is consistent with that of FIGS. 4 and 7.

The white vertical lines are shown bisecting the circular EOPA structure, or mechanical aperture, as shown in FIG. 4, and these diameters are parallel to the diameters separating the semi-circular parts shown in FIG. 7 or the diameter formed by the separation of the polarizers in FIG. 4. As depicted, opening 803 has no voltage applied to the LC cell and therefore is open and transmits polarized light whose axis' orientation is given by the dotted line in 803. Surrounding opening 803, area 801 is the driven LC cell area which is closed and not transmissive. Semi-circular area 802, comprised of regions 805 is closed, and 806 is open, will not transmit light with respect to a polarizer whose axis is oriented in the direction of the dotted line axis shown in 803 as will be explained.

Hence the patterned polarizer with similar orientation cannot transmit image information of this left perspective view and polarization orientation to the pixels in the underlying sensor. Element 802 is opaque to such a pixel because area 805 is driven to be closed and in addition the polarization axis of element 806 is orthogonal to the axis of opening 803 and therefore half the patterned polarizer pixels see only one perspective view. The light from opening 803 reaches half of the pixels underlying the patterned polarizer with their axes parallel to the dotted line axis of opening 803, and the light from aperture 806 is transmitted to the other half through the patterned retarder.

An identical argument can be given to explain why light from aperture 806 can be seen by the other half of the patterned polarizer areas that have polarization axes parallel with that of aperture 806. Thus only one perspective view reaches one set of pixels and the other perspective the other.

The device which is described above is an on or off device in which there are regions of addressed pixels which are open or closed and the open areas transmit polarized light. But the device can also function as a modulator by adjusting the voltage to the open pixels and thus have neutral density properties.

FIG. 8B is another example of a non-circular aperture design and left and right apertures are semi-circles. 813 and 814 represent an observer's view of the EOPA from the image sensor looking through polarizers whose axes are orthogonal as described above for FIG. 7. Semi-circular aperture 809 with polarization axis 809′ is shown transmitting left perspective light and semi-circular aperture 812 with polarization axis 812′ is shown transmitting right perspective image light. The axes 809′ and 812 are orthogonal. The interaxial spacing is determined by the locations of the effective lens axes which lie within each semi-circular aperture. The axes orientation depicted is consistent with that of FIG. 7.

Both semi-circular halves of LC cell ensemble 702, 708 and 709, are un-driven or open. Thus portion 810 is occluded from the point of view of our observer if the axis of the polarizer through which he is looking is orthogonal to axis 809′. Portion 811 is occluded from the point of view of the observer looking in the direction of the aperture if the axis of the polarizer through which he is looking is orthogonal to axis 812′. For the case of a mechanical aperture with sheet polarizers as in FIG. 4, this configuration is made up of two semi-circular linear polarizers whose axes are orthogonal. The patterned polarizer with areas that have axes parallel to 809′ pass the left image through the patterned retarder to the appropriate underlying sensor pixels. Similarly, the patterned polarizer with areas that have axes parallel to 812′ pass the right image to the appropriate underlying sensor pixels.

FIG. 8C is a schematic illustration of one possible means for producing a pixel based EOPA. Element 815 is the left half of the EOPA and element 816 is the right half of the EOPA. The configuration shown here is for a single lens with dual apertures but a worker skilled in the art will understand that this embodiment can be altered to work for a two lens solution. Indicator 817′ points to one aperture and indicator 818′ to the other. The dotted lines within the apertures represent the polarization axes which are orthogonal to one another. Each black rectangle represents an energized pixel and the white squares represent the un-energized pixels as described with the help of FIG. 7. Each square pixel is individually addressed by either the edge driven means described briefly elsewhere or by means of transistors as would be the case for a conventional liquid crystal display. Each half of the EOPA is, generally, bilaterally symmetrical with respect to a vertical mid-line as shown by the board vertical white line. That which is represented here is simplified for purposes of explanation and a higher resolution grid is capable of smoother curves to allow for a finer approximation of curves such as circles. Those skilled in the art will understand that the size and shape of the apertures may be altered by means described here. In addition, the distance between the apertures may be altered by addressing different rows and columns of pixels, thereby changing the interaxial distance.

It is possible to depart from a circular aperture opening and provide the basic functionality of an aperture, namely to modulate the exposure light necessary for creating a well exposed image. A circular aperture has limitations in terms of light gathering in the context of interaxial reduction as taught here since the size of the diameter of the apertures must be reduced as they approach each other. It is possible, with the help of optical design ray tracing tools, to create new aperture shapes to meet the requirements of this art in the sense that such analysis can provide aperture designs for a reduced interaxial distance while maximizing the apertures' light transmission.

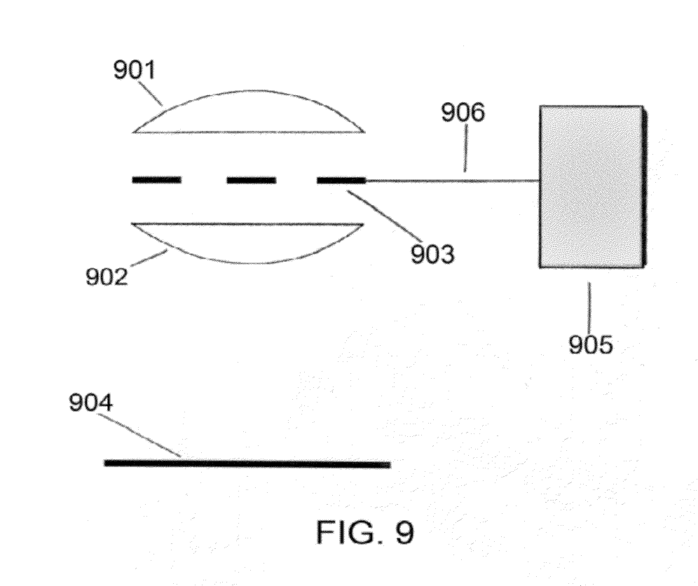

FIG. 9 is a diagram showing how the aperture apparatus 903 is controlled by circuit 905 connected to it by means of cable 906. Complex lens 901/902 is shown as is sensor/polarizer pattern 904. Circuit 905 controls the LC ensemble by driving individual pixels of the EOPA to alter aperture shape and size and also to change the interaxial distance.

Thus the present design in one embodiment includes a stereoscopic motion picture camera having a lens with a polarizing aperture separation layer. The polarizing aperture separation layer is located proximate an optical center of the lens, and the polarizing aperture separation layer comprises at least one polarizer and an aperture plate having at least one opening therein. The embodiment also includes a patterned polarization analyzer configured to receive light energy from the lens and an electronic sensor configured to receive light energy from the patterned polarization analyzer. The polarizing aperture separation layer and patterned polarization analyzer enable the electronic sensor to capture segregated left and right perspective views.

A new technology using polarizing apertures for imaging both left and right perspective views onto a single sensor has been described. In addition the polarizing apertures can be used to image each

What is claimed is:

1. A stereoscopic motion picture camera, comprising:
a lens comprising a polarizing aperture separation layer, the polarizing aperture separation layer located proximate an optical center of the lens and comprising at least one polarizer and an aperture plate having at least one opening therein;
a patterned polarization analyzer configured to receive light energy from the lens; and
an electronic sensor configured to receive light energy from the patterned polarization analyzer;
wherein the polarizing aperture separation layer and patterned polarization analyzer enable the electronic sensor to capture segregated left and right perspective views.

2. The stereoscopic motion picture camera of claim 1, wherein the polarizer comprises a wire grid polarizer.

3. The stereoscopic motion picture camera of claim 1, wherein the polarizer comprises a sheet polarizer.

4. The stereoscopic motion picture camera of claim 1, wherein the polarizer comprises a linear polarizer.

5. The stereoscopic motion picture camera of claim 1, wherein the polarizer comprises a circular polarizer.

6. The stereoscopic motion picture camera of claim 1, wherein the polarizing aperture layer comprises a plurality of areas having different polarization characteristics.

7. The stereoscopic motion picture camera of claim 6, wherein the plurality of polarizers comprise two polarizers having orthogonal axes.

8. The stereoscopic motion picture camera of claim 6, wherein the plurality of polarizers comprise a left circular polarizer and a right circular polarizer.

9. The stereoscopic motion picture camera of claim 1, wherein the polarizing aperture layer is electronically driven.

10. The stereoscopic motion picture camera of claim 1, wherein the polarizing aperture layer comprises an LC element.

11. The stereoscopic motion picture camera of claim 1, wherein two axes are defined by the aperture plate, the two axes separated by less than 2.5 inches.

12. The stereoscopic motion picture camera of claim 1, further comprising a redirecting element positioned between the lens and the patterned polarization analyzer.

13. The stereoscopic motion picture camera of claim 12, wherein the redirecting element comprises a semi-silvered reflecting surface.

14. The stereoscopic motion picture camera of claim 12, wherein the redirecting element comprises a wire grid polarizer.

15. The stereoscopic motion picture camera of claim 1, wherein the lens comprises:
an outer lens piece and an inner lens piece separated by the polarizing aperture separation layer, the polarizing aperture separation layer comprising an aperture plate defining two passageways defined by two axes.

16. The stereoscopic motion picture camera of claim 1, wherein the lens comprises:
a pair of lenses, each lens separated by a polarizing aperture separation layer, each polarizing aperture separation layer comprising an aperture plate defining one passageway defined by an axis.

17. The stereoscopic motion picture camera of claim 12, wherein the redirecting element is configured to provide light energy to a second patterned polarization analyzer and a second electronic sensor.

18. A stereoscopic motion picture camera, comprising:
a plurality of lenses separated by at least one polarizing aperture layer positioned proximate an optical center of the lens, the polarizing aperture layer in each lens comprising at least one polarizer and an aperture plate having at least one opening therein;
a patterned polarization analyzer configured to receive light energy from the multiple element lens arrangement; and
an electronic sensor configured to receive segregated light energy from the patterned polarization analyzer.

19. A stereoscopic motion picture camera, comprising:
polarized apertured lensing means configured to receive light energy and convert the light energy into a plurality of beams of separated light energy;
patterned polarization means configured to receive the plurality of beams of separated light energy from the polarized apertured lensing means and selectively pass one of the plurality of beams; and
electronic sensing means configured to receive separated light energy from the patterned polarization means.

20. The stereoscopic motion picture camera of claim 19, further comprising:
diversion means positioned between the polarized apertured lensing means and the patterned polarization means and configured to divert selected beams to a second patterned polarization means.
